(19) United States
(12) Patent Application Publication
(10) Pub. No.: US 2002/0068529 A1
(43) Pub. Date: Jun. 6, 2002

(54) System and method for adapting traditional telephony for cellular usage

(76) Inventor: John L. Knoble, Rose Valley, PA (US)

Correspondence Address: KNOBLE & YOSHIDA, EIGHT PENN CENTER, SUITE 1350, 1628 JOHN F KENNEDY BLVD, PHILADELPHIA, PA, 19103, US

(21) Appl. No.: 09/727,895

(22) Filed: Dec. 1, 2000

(51) Int. Cl. H04Q 7/20

(52) U.S. Cl. 455/74.1; 455/426; 455/403; 455/550

(57) ABSTRACT

A system and method for permitting a standard telephone system such as the telephones and cabling that may be found within a typical residence to be converted for cellular usage includes a first connector for connecting to a cellular telephone, a second connector for connecting to the telephone system and a conversion unit for converting signals that are received from the cellular telephone to signals that emulate those of the public switched telephone network, and likewise converting signals that are received from the telephone system into signals that are decipherable by the cellular telephone. The system may be deployed in, for example, a home residence by disconnecting the residence from the public switched network and then connecting the system into the wiring that remains in the residence. At least one cellular telephone is then coupled to the first connector of the system. When a user picks up a standard telephone within the residence, he or she will hear in a dial tone that is indistinguishable from that which is typically generated by the public switched network. The user may then place an outgoing telephone call by dialing with the standard telephone, with the dialing signals and subsequent voice transmission being routed by the system through the cellular telephone. Similarly, when an incoming call is received by the cellular telephone, the system will generate a ring signal that is emulative of that which is typically produced by the public switched network. The system thus approximates the feel of a conventional telephone system while permitting consumers to avoid paying for redundant telephone service.

### BACKGROUND OF THE INVENTION

1. Field of the Invention

This invention pertains generally to the field of telecommunications, and more specifically to a system and method for adapting traditional telephony for cellular usage.

2. Description of the Related Technology

In decades past, the typical American household relied on a single telephone line, which was invariably wired to the public switched telephone system, for all of its telecommunication needs. Beginning in the 1980's, however, the advent of the facsimile machine and the Internet in conjunction with the trend toward telecommuting led many consumers to install one or more additional telephone lines. At the same time, many consumers acquired cellular telephones as well. The combined effect of these trends has caused the amount of telephone lines and assigned telephone numbers to multiply nationally to the point where many metropolitan areas that had adequately been serviced by one area code now spread over several area codes.

These days, it is not unusual for a household with two working spouses to be paying several hundred dollars per month to maintain a pair of conventional telephone lines and another pair of cellular telephone bills. FIG. 1 depicts a home 10 for such a household, which includes a telephone system 12 having a number of traditional telephones T1, T2, T3 and T4, each of which is connected to the telephone system 12 using the conventional wall outlet and modular plug. Some of the telephones TI, T2, T3 and T4 may be traditional wired phones having handsets, some may be wireless phones having base stations and battery-powered transceiver units, while others may be speakerphones or headset units. Other appliances, such as computers with modems, Internet access appliances and facsimile machines may likewise be connected to the telephone system 12. In addition, the household may have more than one telephone system 12, one of which may be connected to a home office, for example, or reserved for facsimile or Internet access.

As FIG. 1 shows, the conventional telephone system 12 is connected to the public switched network 14 by external cabling 16. In some instances, there may be multiple connections to the public switched network 14, such as when the household is serviced by more than one telephone line. In addition, the telephone system 12 may also be used to provide other data services, such as DSL Internet service, via the outdoor cabling 16 and the local switching office of the public switched network.

In addition to the wired telephone services that are accessed through the traditional public switched network 14, the household depicted in FIG. 1 pays for cellular telephone service for two separate cellular telephones C1 and C2. Again, it would not be unusual for such a household to have monthly telephone bills totaling several hundred dollars a month.

Many consumers recognize that a great deal of redundancy and waste exists in this type of situation, and some have canceled conventional telephone service in favor of using the cellular phone full-time. Most, however, are reluctant to take this step, despite the growing availability of reasonably priced unlimited cellular service, sometimes even including free long-distance service as well. In the inventor's opinion, there are several reasons for this. One may be that consumers are concerned about the long term health risks of prolonged cellular telephone usage. Another reason may be that consumers find that it is more convenient to use the conventional telephone line, which may have extensions in several different rooms within the home, than to carry the cellular telephone with them as they move from room to room. Some consumers, including the inventor, feel that the quality of cellular reception within some or all areas of their home is insufficient for full-time use. Other consumers may simply feel more comfortable with the features of the conventional telephone, whether it be the size and shape of a favorite phone, the familiar sound of the dial tone or a preference for a speakerphone.

A need exists for a system and method to permit consumers and businesses to avoid redundant telephone service and the costs that are associated with such redundancy.

### SUMMARY OF THE INVENTION

Accordingly, it is an object of the invention to provide a system and method to permit consumers and businesses to avoid redundant telephone service and the costs that are associated with such redundancy.

In order to achieve the above and other objects of the invention, a method of converting a telephone system that has been connected to the public switched network for cellular usage includes, according to a first aspect of the invention, disconnecting the telephone system from the public switched network; providing an adapter unit that is constructed and arranged to connect to at least one cellular telephone at a first point of connection and to the telephone system at a second point of connection, the adapter including a converter for converting at least one signal from the cellular telephone to at least one signal that is appropriate for use by the telephone system and for converting at least one signal from the telephone system to a signal that is appropriate for use by the cellular telephone; and connecting the adapter unit to the telephone system.

According to a second aspect of the invention, an apparatus for converting a telephone system that has been connected to the public switched network for cellular usage includes first connection structure for connecting the apparatus to a cellular telephone; second connection structure for connecting the apparatus to the telephone system; and converting structure for converting at least one signal from the cellular telephone to and from at least one signal that is appropriate for use by the telephone system.

According to a third aspect of the invention, a telephone system that is adapted for cellular usage includes at least one telephone that is constructed and arranged for use using a standard public switched network protocol; and a cellular conversion apparatus including first connection structure for connecting the apparatus to a cellular telephone, second connection structure for connecting the apparatus to the telephone, and converting structure for converting at least one signal from the cellular telephone to and from at least one signal that is appropriate for use by the telephone.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagrammatical depiction of a typical household that pays for a redundancy in telephone service;

FIG. 2 is a diagrammatical depiction of a household having a telephone system that is converted for cellular usage according to a preferred embodiment of the invention;

FIG. 3 is a diagrammatical depiction of a system for converting a conventional telephone system for cellular usage that is constructed according to a first embodiment of the invention;

FIG. 4 is a diagrammatical depiction of a system for converting a conventional telephone system for cellular usage that is constructed according to a second embodiment of the invention; and

FIG. 5 is a schematic depiction of the electronic control system for the system for converting a conventional telephone system for cellular usage that is illustrated in FIG. 3.

### DETAILED DESCRIPTION OF THE PREFERRED EMBODIMENT(S)

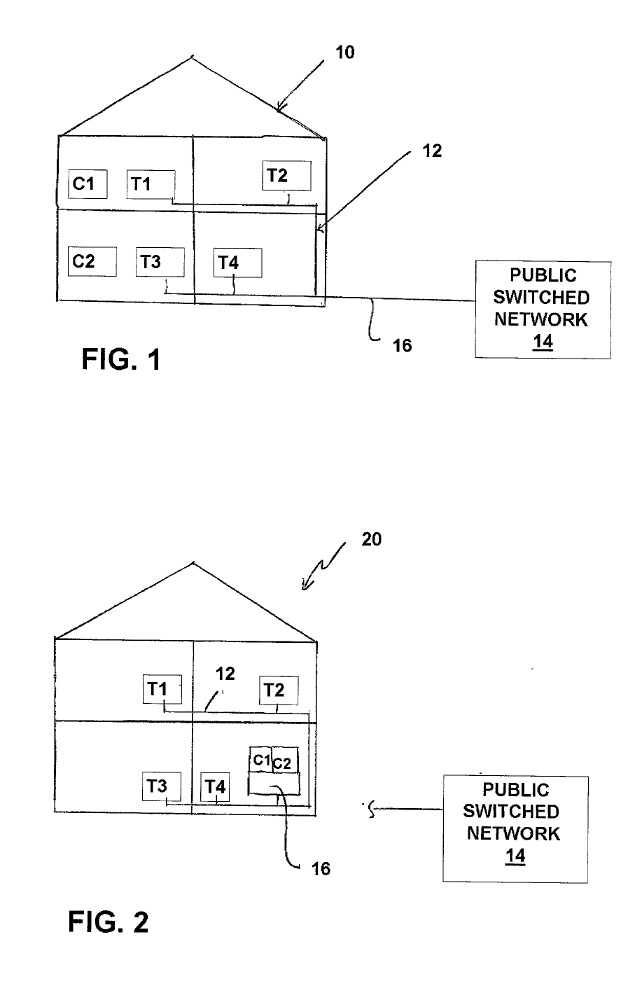

Referring now to the drawings, wherein like reference numerals designate corresponding structure throughout the views, and referring in particular to FIG. 2, a building 20 is depicted having a telephone system 12 that is identical to that described above with reference to FIG. 1, except that it has been converted for cellular usage by means of an apparatus 16 that is constructed according to a preferred embodiment of the invention. Building 20 may detect an individual household, more than one household, or a business establishment, as will be apparent from the description of the capabilities of the apparatus 16 provided below.

As may be seen in FIG. 2, the two cellular telephones C1, C2 have been connected to the apparatus 16, and the apparatus 16 or adapter unit is likewise connected to the telephone system 12. In addition, the telephone system 12 has been disconnected from the public switched 11 network 14.

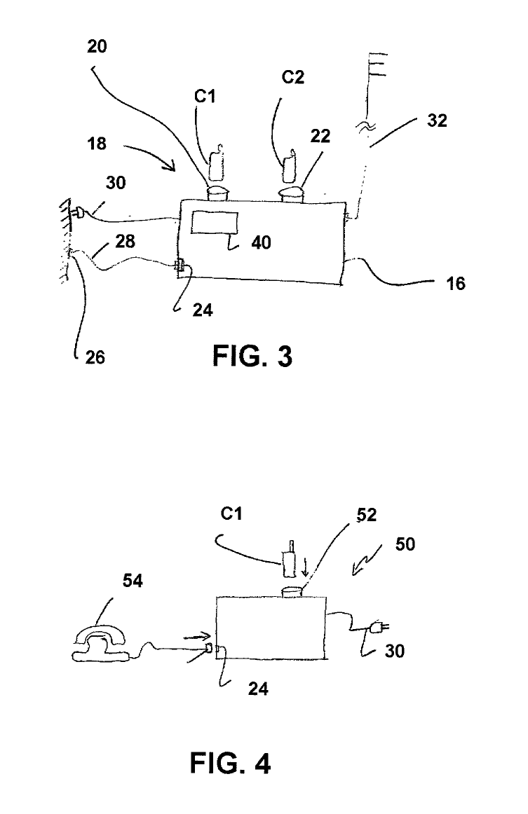

Referring them to FIG. 3, the apparatus or adapter unit 16 preferably includes a first connector or number of connectors 18 for connecting the apparatus 16 to one or more cellular telephones. In the illustrated embodiment, these are embodied as a first receptacle or socket 20 for receiving cellular telephone C1, and a second receptacle or socket 22 for receiving the second cellular telephone C2. Receptacles 20,22 most physically be configured to meet with the connection socket that is typically provided that the bottom of the cellular telephone. Such connection sockets differ in their configuration, both electronically and mechanically depending upon the manufacturer and model of cellular telephone that is involved. Accordingly, receptacles 20,22 are preferably provided as modular units that are customized for the particular cellular telephone models that are being used by the occupants of the building 20. It is anticipated that customers will be able to order the appropriate modular unit for their own cellular telephone to interconnect with the apparatus 16, and such modular units will continue to be made commercially available even as new manufacturers and models of cellular telephones become available. Receptacles 20,22 preferably are designed to make contact with all of the electrical components of the connection sockets of the cellular telephone for which they are designed, so as to permit recharging of the cellular telephone when it is positioned within the receptacle 20 or 22, and so as to permit the apparatus 16 to communicate with the logic functions of the cellular telephone as well.

Looking again to FIG. 3, the apparatus or adapter 16 also includes a second connector or number of connectors 24 for connecting the apparatus 16 to the telephone system 12. In the preferred embodiment, second connector 24 is embodied as a standard modular telephone receptacle, through which apparatus 16 may be connected to the telephone system 12 within the building 20 by means of a standard modular cable 28 that is plugged into a standard modular telephone wall jack 26. The apparatus 16 is preferably powered using household power obtained by a power cord 30 that is plugged into a standard household wall outlet. In addition, apparatus 16 preferably includes an antenna 32 for enhancing cellular telephone reception of the cellular telephones C1, C2, or, alternatively, a connection point for installing such an antenna. Apparatus 16 could alternatively include repeater technology for receiving low-level cellular signals and rebroadcasting those signals for facilitated reception by the cellular telephones.

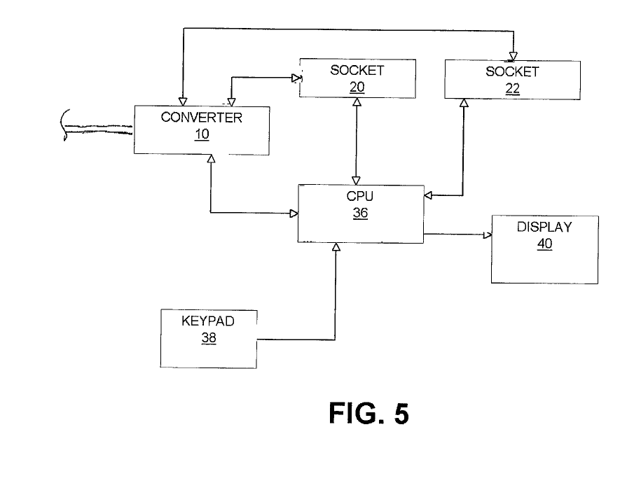

Referring briefly to FIG. 5, apparatus 16 includes a control system including a converter or conversion module 34, a CPU 36, a keypad 38 and a display module 40. The converter 34 is capable of converting at least one signal from a cellular telephone to and from at least one signal that is appropriate for use by the telephone system 12, which of course is constructed and arranged for use not with cellular telephony, but with the public switched network 14. Specifically, converter 34 is capable of receiving an electronic signal from one of the cellular telephones C1, C2 that indicates an incoming call to the cellular telephone, and converting the signal to a ring signal that is sufficient to cause telephones T1, T2, T3 and T4 to ring as if they would if receiving a call through the public switched network. In the preferred embodiment, this would be accomplished by generating a first ring pattern indicating that the incoming call is being received through cellular telephone C1, or a second ring pattern indicating that the incoming call is being received through cellular telephone C2. For example, if a call is being received through the first cellular telephone, which might be the husband of the household, the ring pattern may be one short ring, followed by a longer ring. A call being received through the second cellular telephone, which might be for the wife of the household, might be indicated by two longer rings. In this way, the occupants of the household will know in advance the intended recipient of the telephone call.

Converter 34 is further constructed and arranged to receive a signal from the respective cellular telephone C1 or C2 that represents the voice, voices or other sounds being received by the cellular telephone during a telephone connection, and to convert this signal into a comparative signal using the protocol of the public switched network 14. In addition, when someone within the building 20 picks up one of the telephones T1, T2, T3 and T4 in order to initiate a telephone call, converter 34 will produce a signal that emulates the familiar dial tone of the public switched network 14. Converter 34 is further constructed and arranged to convert the voice signal of a person speaking on one of the telephones T1, T2, T3 and T4 into a signal that is of the proper protocol for electronic communication to the cellular telephone as to initiate an outgoing transmission. Most commercially available cellular telephones have connectors that permit such external audio input and export, because most support their own headset units and automobile kits.

Another function of converter 34 is that when a user picks up one of the conventional telephones T1, T2, T3 and T4 to initiate an outgoing telephone call, and the converter 34 emulates the dial tone of the public switched network, the converter 34 is constructed and arranged to recognize the dialing signal produced by the telephone T1, T2, T3 or T4 (whether that signal be pulse or tone), and convert that dialing signal to a signal that is protocol compatible with the cellular telephone C1, C2 to instruct that cellular telephone to initiate the outgoing telephone call. Optionally, converter 34 may be programmed to permit such dialing signal conversion even during a telephone connection, so that the user will be able to instruct automated menus, etc. even when using a telephone that is limited to pulse dialing. The converter 34 is further programmed to sense when none of the conventional telephones T1, T2, T3 and T4 are being operated, so as to terminate any cellular connection.

In order to permit converter 34 to function, it must be programmed to be compatible with the protocol and embedded logic firmware of the cellular telephones that are in use. The specific programming, then, will differ according to the specific cellular telephone that is involved, and is well within the level of ordinary skill in the relevant art. In order to achieve this, one option would be to manufacture a number of different models of apparatus 16, each of which is compatible with a particular model of cellular telephone. A second option would be to provide a preprogrammed logic chip within each modular receptacle, to ensure protocol compatibility. A third option would be to permit the user to configure the apparatus 16 for a particular model of cellular telephone, perhaps by entering a code via the keypad 38. The CPU 36 may have a memory module that stores the relevant conversion information for a number of different models of cellular telephones, or the setup process could involve connecting the apparatus 16 to the public switched network in order to download the necessary information.

In the preferred embodiment, converter 34 is programmed to electronically monitor whether or not the cellular telephone indicates that voice mail or e-mail has been received, and then notify occupants of the building 20 of such with a distinctive ring pattern that is transmitted through the conventional telephones T1, T2, T3 and T4.

When an outgoing call is initiated, CPU 36 instructs converter 34 through which cellular telephone the call is to be transmitted. In the preferred embodiment, CPU 36 is programmed during the setup process by the user to indicating the preferred cellular telephone for outgoing long distance calls. For example, if cellular telephone C1 is on a service plan that allows for unlimited free long distance calls and cellular telephone C2 is not, the user would presumably programmed the CPU 36 to initiate call long distance calls using cellular telephone C1. If the owner of cellular telephone C1 is out of the house, and cellular telephone C1 is as a result not connected to the apparatus 16, CPU 36 would, of course, initiate any telephone calls using the second cellular telephone C2. However, CPU 36 could be programmed to warn the user in such a circumstance with a prerecorded message indicating that a long distance charge is about to be incurred. Similarly, if neither of the cellular telephones C1, C2 are connected to the apparatus 16, a user are trying to initiate an outgoing telephone call will be given a prerecorded message indicating that no telephone service is presently available.

Alternatively, CPU 36 could be programmed to monitor the number of connection minutes on both cellular telephones C1, C2 and attempt to balance the number of minutes on the to the cellular telephones as outgoing telephone calls are initiated. If such services available through the cellular service provider, CPU 36 could be programmed to periodically automatically retrieve information regarding the service plan and usage of both cellular telephones in order to economically optimize usage.

Many cellular service providers are now offering Internet access via cellular telephone. In order to capitalize on this service, apparatus 16 could further be constructed and arranged so as to be able to convert this data to and from a protocol that would be understandable by a personal computer or Internet appliance. Apparatus 16 could be provided with a connector for this purpose, which could be an ethernet port or a USB port that could easily be connected to a personal computer.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A method of converting a telephone system that has been connected to the public switched network for cellular usage, comprising steps of:
(a) disconnecting the telephone system from the public switched network;
(b) providing an adapter unit that is constructed and arranged to connect to at least one cellular telephone at a first point of connection and to the telephone system at a second point of connection, said adapter unit comprising converter means for converting at least one signal from said cellular telephone to at least one signal that is appropriate for use by said telephone system and for converting at least one signal from said telephone system to a signal that is appropriate for use by said cellular telephone; and
(C) connecting said adapter unit to the telephone system.

2. A method according to claim 1, further comprising a step of connecting a cellular telephone to the adapter unit.

3. A method according to claim 1, wherein said telephone system comprises the internal telephone wiring for a building.

4. A method according to claim 1, wherein step (c) comprises connecting said adapter unit to a pre-existing modular receptacle in said telephone system.

5. A method according to claim 1, wherein said adapter unit is further constructed and arranged to connect to a second cellular telephone, and further comprising a step of connecting the second cellular telephone to the adapter unit.

6. An apparatus for converting a telephone system that has been connected to the public switched network for cellular usage, comprising:
first connection means for connecting said apparatus to a cellular telephone;
second connection means for connecting said apparatus to the telephone system; and
converting means for converting at least one signal from said cellular telephone to and from at least one signal that is appropriate for use by said telephone system.

7. An apparatus according to claim 6, wherein said first connection means comprises a receptacle for receiving the cellular telephone.

8. An apparatus according to claim 7, wherein said first connection means further comprises a modular receptacle that is customized for a particular cellular telephone model.

9. An apparatus according to claim 6, wherein said first connection means includes means for charging the cellular telephone.

10. An apparatus according to claim 6, further comprising an antenna for enhancing cellular telephone communications, and wherein said first connection means includes means for coupling said antenna to the cellular telephone.

11. An apparatus according to claim 10, wherein said means for coupling said antenna to the cellular telephone includes a signal amplifier.

12. An apparatus according to claim 6, wherein said second connection means comprises a standard modular telephony connector.

13. An apparatus according to claim 6, further comprising a dataport for data communications.

14. An apparatus according to claim 6, wherein said converting means is constructed and arranged to emulate a dial tone from the public switched network, and to communicate said dial tone to said second connection means.

15. An apparatus according to claim 14, wherein said converting means is further constructed and arranged to communicate said dial tone to said second connection means when a cellular telephone is connected to said apparatus.

16. An apparatus according to claim 6, wherein said converting means is constructed and arranged to emulate a ring voltage from the public switched network, and to communicate said ring voltage to said second connection means.

17. An apparatus according to claim 16, wherein said converting means is further constructed and arranged to communicate said ring voltage to said second connection means when a cellular telephone is connected to the apparatus and the cellular telephone is receiving an incoming call.

18. An apparatus according to claim 6, wherein said converting means is constructed and arranged to receive a dialing signal via said second connection means and to generate a signal that is transmitted to said first connection means that is appropriate to instruct a cellular telephone to place an outgoing telephone call in accordance with said dialing signal.

19. A telephone system that is adapted for cellular usage, comprising:
at least one telephone that is constructed and arranged for use using a standard public switched network protocol; and
a cellular conversion apparatus including first connection means for connecting said apparatus to a cellular telephone, second connection means for connecting said apparatus to said telephone, and converting means for converting at least one signal from said cellular telephone to at least one signal that is appropriate for use by said telephone.

20. A telephone system according to claim 19, further comprising telephone cabling that is provided within at least one building, and wherein said telephone cabling is connected to said telephone at a first location and to said second connection means at a second location.
